(19) United States
(12) Patent Application Publication
(10) Pub. No.: US 2023/0191607 A1
(43) Pub. Date: Jun. 22, 2023

(54) ROBOT AND CONTROL METHOD THEREFOR

(71) Applicant: SAMSUNG ELECTRONICS CO., LTD, Suwon-si (KR)

(72) Inventor: Minkuk KIM, Suwon-si (KR)

(73) Assignee: SAMSUNG ELECTRONICS CO., LTD, Suwon-si (KR)

(21) Appl. No.: 18/112,258

(22) Filed: Feb. 21, 2023

Related U.S. Application Data
(63) Continuation of application No. PCT/KR21/12589, filed on Sep. 15, 2021.

(30) Foreign Application Priority Data
Oct. 7, 2020 (KR) 10-2020-0129352

(51) Int. Cl. B25J 9/16; B25J 19/00

(52) U.S. Cl. CPC B25J 9/1674; B25J 19/005

(57) ABSTRACT

A robot and a control method therefor are provided. The robot may include: a plurality of batteries; a first switch configured to individually supply electric energy provided from an external charger to the plurality of batteries; a second switch configured to connect the plurality of batteries; and a processor configured to: based on the external charger being connected to the robot, control the first switch such that at least one battery of the plurality of batteries is selectively charged based on respective states of charge (SOCs) of the plurality of batteries, and then remaining batteries of the plurality of batteries are charged, and based on an SOC difference between respective SOCs of at least two of the plurality of batteries reaching a difference threshold while the external charger is disconnected from the robot, control the second switch such that a source battery having a high relative SOC among the plurality of batteries charges a recipient battery having a low relative SOC among the plurality of batteries.

### CROSS-REFERENCE TO RELATED APPLICATIONS

This application is a continuation application of International Application No. PCT/KR2021/012589, filed on Sep. 15, 2021, which is based on and claims priority to Korean Patent Application No. 10-2020-0129352, filed on Oct. 7, 2020 in the Korean Intellectual Property Office, the disclosures of which are incorporated by reference herein in their entireties.

### BACKGROUND

### 1. Field

The disclosure relates to a robot and a control method therefor, and more particularly, to a robot including a plurality of batteries, and a control method therefor.

### 2. Description of Related Art

A conventional robot may simultaneously charge a plurality of batteries included in the robot when an external charger is connected. However, a plurality of batteries may have different discharge times according to their uses, and accordingly, each battery may have a different state of charge (SOC) when an external charger is connected. As above, when a plurality of batteries are simultaneously charged while the plurality of batteries have different SOCs, the charging of a battery having a high SOC is completed earlier than that of a battery having a low SOC. In this case, even though the battery having a low SOC is not completely charged, the battery manage system (BMS) stops the charging as the battery having a high SOC is fully charged. This ultimately brings a result that the operation time of the robot is reduced.

Additionally, as described above, a plurality of batteries have different discharge times according to their uses, and thus some batteries among the plurality of batteries may be discharged earlier than the other batteries according to operation of the robot. If any one battery is fully discharged as above, a conventional robot requires charging of all of the plurality of batteries to resume operation of the robot, even though the remaining batteries are not discharged.

Accordingly, there is a need to increase the operation time of the robot, and resolve user inconvenience that may occur due to frequent charge by delaying the discharge times of the plurality of batteries included in the robot.

### SUMMARY

Provided are a robot which individually charges each of a plurality of batteries when connected to an external charger, wherein some of the plurality of batteries charge other batteries while the robot is operating after connection with the external charger is disconnected, and a control method therefor.

According to an aspect of the disclosure, a robot includes: a plurality of batteries; a first switch configured to individually supply electric energy provided from an external charger to the plurality of batteries; a second switch configured to connect the plurality of batteries; and a processor configured to: based on the external charger being connected to the robot, control the first switch such that at least one battery of the plurality of batteries is selectively charged based on respective states of charge (SOCs) of the plurality of batteries, and then remaining batteries of the plurality of batteries are charged, and based on an SOC difference between respective SOCs of at least two of the plurality of batteries reaching a difference threshold while the external charger is disconnected from the robot, control the second switch such that a source battery having a high relative SOC among the plurality of batteries charges a recipient battery having a low relative SOC among the plurality of batteries.

The processor may be further configured to: receive SOC information of each battery of the plurality of batteries, based on the SOC information, control the first switch to connect the external charger with a first battery having a low relative SOC among the plurality of batteries, to thereby charge the first battery, and after the first battery is charged, control the first switch to connect the external charger with a second battery having a higher SOC than the first battery among the plurality of batteries, to thereby charge the second battery.

The processor may be further configured to, based on the first battery being charged to a predetermined SOC threshold by a constant current (CC) charge method, control the first switch to connect the second battery with the external charger.

The processor may be further configured to: based on the second battery being charged to the predetermined SOC threshold by the CC charge method, control the first switch to connect the first battery with the external charger, and charge the first battery by a constant voltage (CV) charge method, and based on the first battery being fully charged by the CV charge method, control the first switch to connect the second battery with the external charger, and fully charge the second battery by the CV charge method.

The processor may be further configured to, while the robot is operating, receive SOC information from the plurality of batteries, and determine the SOC difference based on the SOC information.

The processor may be further configured to, based on the SOC difference reaching a predetermined current threshold while the source battery charges the recipient battery, control the second switch to disconnect the source battery and the recipient battery.

Based on a current flowing to the plurality of batteries having a value greater than or equal to a predetermined current threshold, the plurality of batteries may perform an overcurrent protection function, and the difference threshold may be set for the robot such that the value of the current flowing from the source battery to the recipient battery is smaller than the predetermined current threshold.

At least one battery of the plurality of batteries may be configured to supply electric energy to a motor of the robot, and at least one other battery of the plurality of batteries is configured to supply electric energy to the processor.

According to an aspect of the disclosure, a control method for a robot includes: based on an external charger being connected to the robot, controlling a first switch such that at least one battery among a plurality of batteries of the robot is selectively charged based on respective states of charge (SOCs) of the plurality of batteries, and then remaining batteries of the plurality of batteries are charged; and based on an SOC difference between respective SOCs of at least two of the plurality of batteries reaching a difference threshold while the external charger is disconnected from the robot, controlling a second switch such that a source battery having a high relative SOC among the plurality of batteries charges a recipient battery having a low relative SOC among the plurality of batteries.

The controlling the first switch may include: receiving SOC information of each battery from the plurality of batteries; based on the SOC information, controlling the first switch to connect the external charger with a first battery having a low relative SOC among the plurality of batteries, to thereby charge the first battery, and after the first battery is charged, controlling the first switch to connect the external charger with a second battery having a higher SOC than the first battery among the plurality of batteries, to thereby charge the second battery.

The controlling the first switch may include, based on the first battery being charged to a predetermined SOC threshold by a constant current (CC) charge method, controlling the first switch to connect the second battery with the external charger.

The controlling the first switch may include: based on the second battery being charged to the predetermined SOC threshold by the CC charge method, controlling the first switch to connect the first battery with the external charger, and charging the first battery by a constant voltage (CV) charge method, and based on the first battery being fully charged by the CV charge method, controlling the first switch to connect the second battery with the external charger, and fully charging the second battery by the CV charge method.

The control method may further include, while the robot is operating, receiving SOC information from the plurality of batteries, and determining the SOC difference based on the SOC information.

The controlling the second switch may include, based on the SOC difference reaching a predetermined current threshold while the source battery charges the recipient battery having a low SOC, controlling the second switch to disconnect the source battery and the recipient battery.

Based on a current flowing to the plurality of batteries having a value greater than or equal to a predetermined current threshold, the plurality of batteries may perform an overcurrent protection function, and the difference threshold may be set for the robot such that the value of the current flowing from the source battery to the recipient battery is smaller than the current threshold.

According to the various embodiments of the disclosure as described above, a robot that can individually charge a plurality of batteries when connected to an external charger and a control method therefor can be provided. In particular, according to the disclosure, the plurality of batteries are individually charged by a CC charge method, and thus the robot can be charged in a state of being capable of operating within a short time.

Also, according to the disclosure, some of the plurality of batteries charge other batteries while the robot is operating after connection with the external charger is disconnected, and thus the operation time of the robot can be increased, and user inconvenience that may occur due to a need for frequent charging may be resolved.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a robot, according to an embodiment of the

disclosure;

FIG. 2 is a block diagram illustrating interconnections between components of a robot, according to an embodiment of the disclosure;

FIG. 3 is a flow chart illustrating a method of charging a plurality of batteries by an external charger, according to an embodiment of the disclosure;

FIG. 4 is a flow chart illustrating a method of charging a battery by another battery among a plurality of batteries, according to an embodiment of the disclosure;

FIG. 5 is a detailed block diagram illustrating a robot, according to an embodiment of the disclosure; and

FIG. 6 is a flow chart illustrating a control method for a robot, according to an embodiment of the disclosure.

### DETAILED DESCRIPTION

In this disclosure and the corresponding claims, general terms were selected in consideration of the functions described in the disclosure. However, the terms may vary depending on the intention of those skilled in the art, legal or technical interpretation, or emergence of new technologies, etc. Also, certain terms were arbitrarily designated, and in such cases, the meaning of the terms will be interpreted as defined in this disclosure. If there is no specific definition of the terms provided, the meaning of the terms will be interpreted based on the overall content of the disclosure and common technical knowledge in the pertinent technical field.

Also, if detailed explanation of related known functions or configurations may unnecessarily confuse the gist of the disclosure, the detailed explanation will be abridged or omitted.

Further, while the embodiments of the disclosure will be described in detail with reference to the following accompanying drawings and the content illustrated therein, it is not intended that the disclosure is restricted or limited by the embodiments illustrated in the drawings.

Hereinafter, the disclosure will be described in detail with reference to the accompanying drawings.

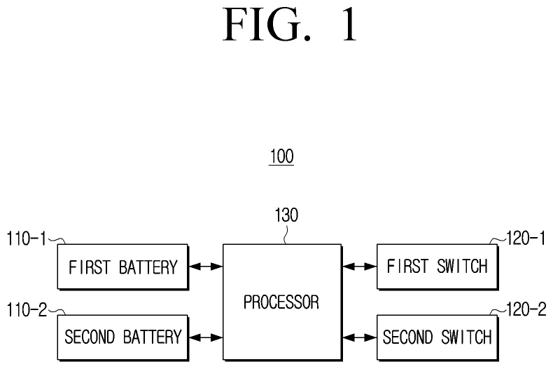

FIG. 1 is a block diagram illustrating a robot, according to an embodiment of the

disclosure.

The robot 100 according to an embodiment of the disclosure may be a robot that can drive around spaces inside a building and perform an air purifying task; a housework supporting robot that can drive around spaces inside a home and perform tasks such as organizing clothes, cleaning, washing dishes, etc.; a robot that can perform a demonstration, an explanation, etc. of products inside a store; a guard robot that can drive around spaces inside a building and perform a guard task, etc.

However, the disclosure is not limited thereto, and the robot 100 may be an autonomous vehicle that can perform driving instead of a person, or an automated guided vehicle that can carry a product to a destination. Also, the robot 100 may be implemented as various electronic devices that may not be traditionally considered “robots,” but which can perform tasks by using electric energy supplied from batteries, such as a smart TV, a smartphone, a computer, a laptop computer, etc.

The robot 100 according to an embodiment of the disclosure may include a plurality of batteries and a plurality of switches. Here, the switches may be field effect transistors (FETs), but are not necessarily limited thereto, and they may be implemented as various switches that can perform connection and disconnection among a plurality of components.

For example, referring to FIG. 1, the robot 100 according to an embodiment of the disclosure may include a first battery 110-1 and a second battery 110-2, and a first switch 120-1 and a second switch 120-2.

Here, each of the plurality of batteries may be connected to different components of the robot 100. As an example, the first battery 110-1 is a battery for operating the processing of the robot 100, and it may be connected with a processor 130 and thereby configured to supply electric energy to the processor 130. Also, the second battery 110-2 is, for example, a battery for operating a manipulation unit of the robot 100, and it may be connected to a motor connected to the manipulation unit and thereby configured to supply electric energy to the motor. Here, the manipulation unit may be the robot arm, the robot hand, the robot leg, etc., but is not necessarily limited thereto.

Further, the robot 100 may include the processor 130, which is connected with the first switch 120-1 and controls the first switch 120-1, and is connected with the second switch 120-2 and controls the second switch 120-2.

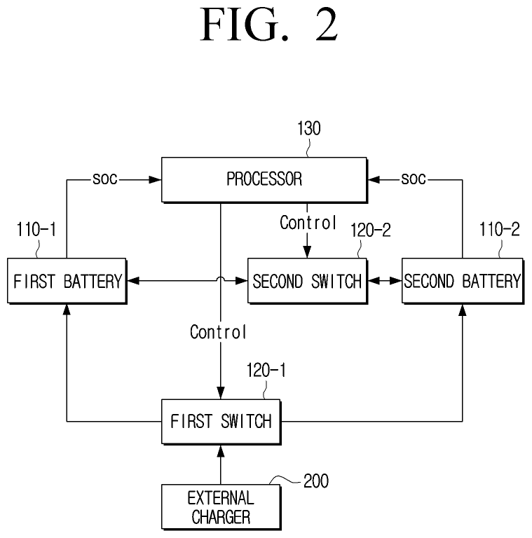

FIG. 2 is a block diagram illustrating interconnections between components of a robot, according to an embodiment of the disclosure.

Here, the first switch 120-1 may be a switch for individually supplying electric energy provided from an external charger to the plurality of batteries, and the second switch 120-2 may be a switch for connecting the plurality of batteries.

For example, referring to FIG. 2, the first switch 120-1 may be electrically connected with the external charger 200, and may be electrically connected with one of the first battery 110-1 or the second battery 110-2 according to control by the processor 130.

Such a first switch 120-1 may be included in a charge unit of the robot 100. The charge unit may further include an interface for connecting with the external charger 200 and being supplied with AC power from the external charger 200, and an AC-DC conversion unit for converting AC power supplied from the external charger 200 into DC power.

Also, the second switch 120-2 may electrically connect the first battery 110-1 and the second battery 110-2 according to control by the processor 130.

For this, the first end of the second switch 120-2 may be connected to the first battery 110-1, the second end may be connected to the second battery 110-2, and the third end may be connected to the processor 130.

Each battery according to the disclosure is a battery that can be charged, and may be implemented as a lithium ion battery, a lithium polymer battery, a nickel cadmium battery, a nickel hydrogen battery, a nickel zinc battery, etc., but is not necessarily limited thereto.

The processor 130 controls the overall operations of the robot 100. For this, the processor 130 may include a central processing unit (CPU) or an application processor (AP). Alternatively, the processor 130 may be implemented as at least one of a general processor, a digital signal processor, an application specific integrated circuit (ASIC), a system on chip (SoC), a microcomputer (MICOM), etc.

First, the operation of the processor 130 while the robot 100 is connected to the external charger 200 will be explained.

When the external charger 200 is connected to the robot 100, the processor 130 may control the first switch 120-1 such that at least one battery of the plurality of batteries is selectively charged on the basis of the states of charge (SOCs) of the plurality of batteries, and then the remaining batteries are charged.

For this, the processor 130 may receive SOC information of each battery of the plurality of batteries. Here, the SOC information may be generated by a battery manage system (BMS) included in each battery.

Then, the processor 130 may control the first switch 120-1 such that a battery having a low relative SOC among the plurality of batteries is charged first, based on the SOC information of each battery received from the plurality of batteries.

As an example, if the SOC of the first battery 110-1 is lower than the SOC of the second battery 110-2, the processor 130 may control the first switch 120-1 to connect the external charger 200 with the first battery 110-1, to thereby first charge the first battery 110-1.

Then, after the first battery 110-1 is charged, the processor 130 may control the first switch 120-1 to connect the external charger 200 with the second battery 110-2, to thereby charge the second battery 110-2 having a higher SOC than the first battery 110-1.

In particular, once the first battery 110-1 is charged to a predetermined SOC threshold by a constant current (CC) charge method, the processor 130 may control the first switch 120-1 such that the second battery 110-2 and the external charger 200 are connected.

Here, the CC charge method is a method of outputting a constant current from the external charger 200 to a battery. In comparison to a constant voltage (CV) charge method applying a constant voltage from the external charger 200 to the battery, the CC charge method can charge a great capacity in the battery in a relatively short time.

The aforementioned predetermined SOC threshold indicates a portion of the capacity of the battery to be charged by the CC charge method, which may be 70% depending on embodiments, but is not necessarily limited thereto.

For this, while the first battery 110-1 is being charged by the external charger 200, the processor 130 may receive SOC information from the first battery 110-1, and determine the SOC of the first battery 110-1. Then, based on the SOC information received from the first battery 110-1, if it is determined that the SOC of the first battery 110-1 has reached the predetermined SOC threshold, the processor 130 may control the first switch 120-1 such that the second battery 110-2 and the external charger 200 are connected.

Alternatively, the external charger 200 may charge the first battery 110-1 to the predetermined SOC threshold by the CC charge method, and when the charge by the CC charge method is completed, the external charger 200 may transmit a CC charge completion signal to the processor 130 through an interface of a charge unit (not shown). In this case, when the CC charge completion signal is received from the external charger 200, the processor 130 may control the first switch 120-1 such that the second battery 110-2 and the external charger 200 are connected.

When the first switch 120-1 is switched to the second battery 110-2 according to control by the processor 130, the second battery 110-2 may be connected with the external charger 200, and may be charged to the predetermined SOC threshold by the CC charge method.

Then, when the second battery 110-2 is charged to the predetermined SOC threshold by the CC charge method, the processor 130 may control the first switch 120-1 such that the first battery 110-1 and the external charger 200 are connected.

For this, while the second battery 110-2 is being charged by the external charger 200, the processor 130 may receive SOC information from the second battery 110-2, and determine the SOC of the second battery 110-2. Then, based on the SOC information received from the second battery 110-2, if it is determined that the SOC of the second battery 110-2 has reached the predetermined SOC threshold, the processor 130 may control the first switch 120-1 such that the first battery 110-1 and the external charger 200 are connected.

Alternatively, the external charger 200 may charge the second battery 110-2 to the predetermined SOC threshold by the CC charge method, and when the charge by the CC charge method is completed, the external charger 200 may transmit a CC charge completion signal to the processor 130 through the interface of the charge unit (not shown). In this case, when the CC charge completion signal is received from the external charger 200, the processor 130 may control the first switch 120-1 such that the first battery 110-1 and the external charger 200 are connected.

When the first switch 120-1 is switched to the first battery 110-1 according to control by the processor 130, the first battery 110-1 may be connected with the external charger 200, and may be charged by a CV charge method.

Then, when the first battery 110-1 is fully charged by the CV charge method, the processor 130 may control the first switch 120-1 such that the second battery 110-2 and the external charger 200 are connected. In this case, the second battery 110-2 may be connected with the external charger 200, and may be charged by the CV charge method.

As described above, according to the disclosure, when the first battery 110-1 is charged by the CC charge method, the first switch 120-1 may be controlled such that the second battery 110-2 and the external charger 200 are connected, and the second battery 110-2 may be charged by the CC charge method. Accordingly, compared with an approach of fully charging the first battery 110-1 by the CC charge method and the CV charge method, and then connecting the second battery 110-2 to the external charger 200, the described embodiment can charge a great capacity in the first and second batteries 110-1, 110-2 within a short time.

In FIG. 2, two batteries are illustrated, but this is merely an example, and the number of the batteries may be three or more depending on embodiments. The principles disclosed herein are also applicable to this case, and it can be seen that the three or more batteries can be individually charged.

After the connection with the external charger 200 is disconnected, if a difference in the respective SOCs of batteries among the plurality of batteries reaches a difference threshold due to operation of the robot 100 using charge from the respective batteries, the second switch 120-2 may be controlled such that a source battery having a high SOC among the plurality of batteries charges a recipient battery having a low SOC.

Here, the operation of the robot 100 may be gripping and carrying of an object through the robot hand, moving of the robot 100, etc., but is not necessarily limited thereto.

Also, the difference threshold may be, for example, 30%, but it may be set as various values according to a user input or other factors.

In particular, the difference threshold may be set based on an overcurrent protection function of the battery. Specifically, if a current flowing to a battery has a size or value greater than or equal to a predetermined current threshold (or, an overcurrent protection value), each battery included in the robot 100 may perform an overcurrent protection function. Here, the overcurrent protection function is a function by the battery manage system of blocking a current having a size greater than or equal to the overcurrent protection value, for preventing damage to the protection circuit, etc. of the battery due to flow of overcurrent in the battery, and the difference threshold may be set such that the value of the current flowing from the battery having a high SOC to the battery having a low SOC is smaller than the overcurrent protection value. As an example, if the overcurrent protection value is K(A), the difference threshold may be set such that the current flowing from the battery having a high SOC to the battery having a low SOC is smaller than K(A).

For this, the processor 130 may receive SOC information from the plurality of batteries while the robot 100 is operating, and determine the difference in the respective SOCs of the plurality of batteries based on the SOC information of each battery.

As an example, if the first battery 110-1 is a battery for operating the system of the robot 100, and the second battery 110-2 is a battery for operating the manipulation unit of the robot 100, the consumption amount of the first battery 110-1 and the consumption amount of the second battery 110-2 may be different when the robot 100 is operated. In particular, if the operation of the robot 100 is carrying a heavy object, the consumption amount of the second battery 110-2 connected to the motor of the manipulation unit will be bigger than that of the first battery 110-1 for operating the system of the robot 100, and accordingly, the difference between the SOC of the first battery 110-1 and the SOC of the second battery 110-2 on one point may reach the difference threshold.

As described above, when the difference between the SOC of the first battery 110-1 and the SOC of the second battery 110-2 reaches the difference threshold according to the operation of the robot 100, the processor 130 may control the second switch 120-2 in an open state to a short-circuited state.

In this case, electric energy charged in the first battery 110-1 having a high SOC may be supplied to the second battery 110-2 having a low SOC.

Specifically, when the difference between the SOC of the first battery 110-1 and the SOC of the second battery 110-2 reaches the difference threshold, the processor 130 may control the second switch 120-2 in an open state to a short-circuited state, and transmit a signal requesting supply of electric energy to the first battery 110-1. In this case, the battery manage system of the first battery 110-1 may charge the second battery 110-2 by supplying electric energy to the second battery 110-2 connected through the second switch 120-2.

Alternatively, the battery manage system of the first battery 110-1 having a high SOC may determine whether the second switch 120-2 was short-circuited, and if it is determined that the second switch 120-2 in an open state was short-circuited according to control by the processor 130, the battery manage system may charge the second battery 110-2 by supplying electric energy to the second battery 110-2. For this, the battery manage system of the first battery 110-1 may monitor a voltage (or, a current) applied to the terminal of the first battery 110-1 connected with the second switch 120-2, detect a change in the voltage (or, the current) that occurs according to switching of the second switch 120-2, and if a change in the voltage (or, the current) is detected, the battery manage system may determine that the second switch 120-2 in an open state was short-circuited.

Afterwards, when the difference in the SOCs of the plurality of batteries reaches a predetermined current threshold as the battery having a high SOC among the plurality of batteries charges the battery having a low SOC, the processor 130 may control the second switch 120-2 to disconnect the connection among the plurality of batteries.

Here, the predetermined current threshold may be, for example, 10%, but this may be set as various values according to a user input or other factors. Accordingly, the disclosed embodiment can prevent overcharge of the second battery 110-2, and can thereby prevent dangers such as damage, explosion, etc. of the second battery 110-2.

As described above, according to the disclosure, the battery having a low SOC can be charged by the battery having a high SOC while the robot 100 is operating. Accordingly, the time point when some batteries among the plurality of batteries are discharged can be delayed, and ultimately, the operation time of the robot 100 can be increased.

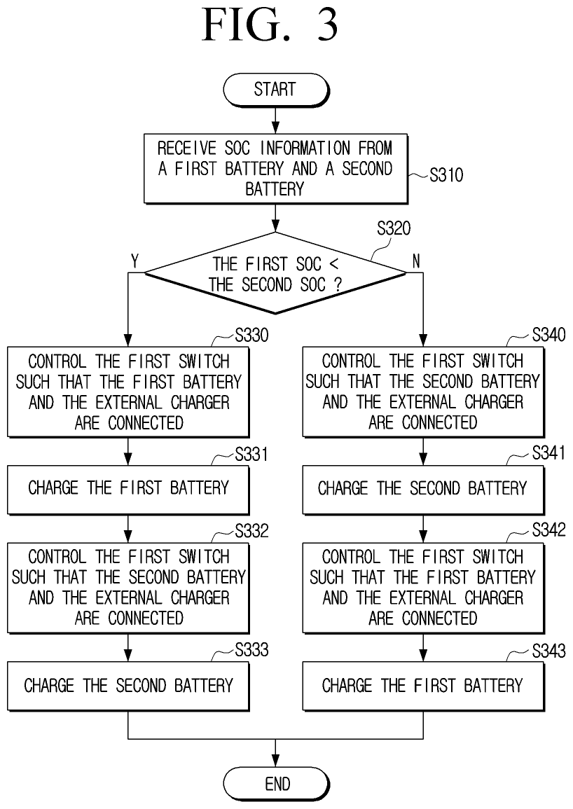

FIG. 3 is a flow chart illustrating a method of charging a plurality of batteries by an external charger, according to an embodiment of the disclosure. Hereinafter, explanation will be described by omitting or abridging parts that overlap with the aforementioned explanation.

The processor 130 may detect connection between the charge unit (not shown) of the robot 100 and the external charger 200. Specifically, when a charge detection signal that was generated by the charge unit (not shown) is received from the charge unit (not shown) as the external charger 200 is connected to the charge unit (not shown) of the robot 100, the processor 130 may determine that the charge unit (not shown) of the robot 100 and the external charger 200 are connected.

Then, the processor 130 may receive SOC information of each battery from the plurality of batteries. As an example, the processor 130 may receive SOC information from the first battery and the second battery in operation S310. Also, the SOC information might not only be received from each battery after connection with the external charger 200 is detected, but might also be received from each battery before the external charger 200 is connected.

Based on the SOC information received from each battery, the processor 130 may determine a battery having a relatively high SOC and a battery having a relatively low SOC among the plurality of batteries. Then, the processor 130 may control the first switch 120-1 such that the battery having a low SOC is charged first.

As an example, if a first SOC which is the SOC of the first battery 110-1 and a second SOC which is the SOC of the second battery 110-2 are received, the processor 130 may compare the sizes of the first SOC and the second SOC in operation S320.

Then, if it is determined that the first SOC is smaller than the second SOC, the processor 130 may control the first switch 120-1 such that the first battery 110-1 and the external charger 200 are connected in operation S330.

Accordingly, the first battery 110-1 may be charged by the external charger 200 in operation S331.

Afterwards, the processor 130 may control the first switch 120-1 such that the second battery 110-2 and the external charger 200 are connected in operation S332.

Specifically, when the first battery 110-1 is charged to a predetermined capacity by the CC charge method, the processor 130 may control the first switch 120-1 such that the second battery 110-2 and the external charger 200 are connected. However, this is merely an example, and it can be deemed that, when the first battery 110-1 is fully charged by the CC charge method and the CV charge method, the processor 130 may control the first switch 120-1 such that the second battery 110-2 and the external charger 200 are connected.

Accordingly, the second battery 110-2 may be charged by the external charger 200 in operation S333. The method then ends.

Although not illustrated in FIG. 3, the method may further include an operation wherein, when the first battery 110-1 is charged to the predetermined capacity by the CC charge method, the processor 130 controls the first switch 120-1 such that the second battery 110-2 and the external charger 200 are connected, and afterwards, when the second battery 110-2 is charged to the predetermined capacity by the CC charge method, the processor 130 controls the first switch 120-1 such that the first battery 110-1 and the external charger 200 are connected.

In addition, the control method may further include an operation wherein, when the first battery 110-1 is fully charged by the CV charge method afterwards, the processor 130 controls the first switch 120-1 such that the second battery 110-2 and the external charger 200 are connected, and fully charges the second battery 110-2 by the CV charge method.

Returning to S320, if it is determined that the first SOC is not smaller than the second SOC, the processor 130 may control the first switch 120-1 such that the second battery 110-1 and the external charger 200 are connected in operation S340. Operations S341 through S343 then operate much as their counterpart operations S331 through S333, but charging the second battery at S341, switching to the first battery at S342, and charging the first battery at S343. The method then ends.

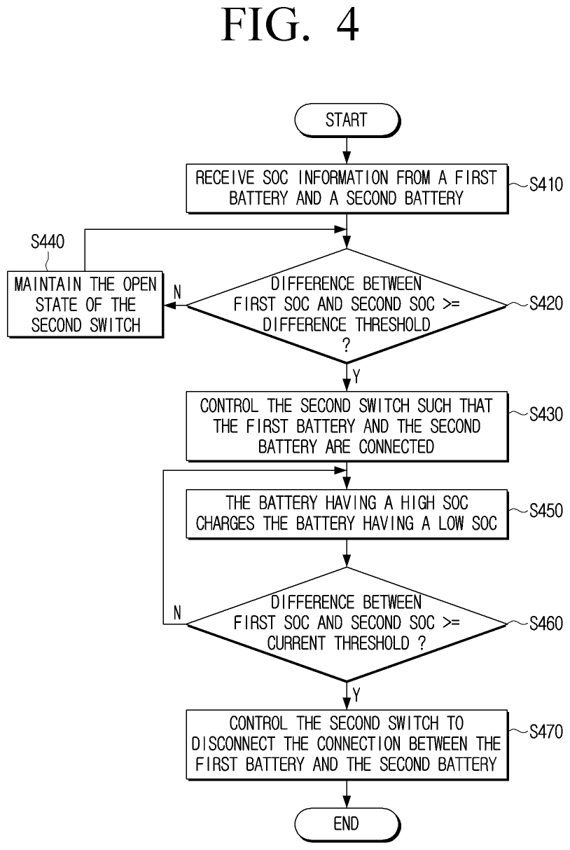

FIG. 4 is a flow chart illustrating a method of charging a battery by another battery among a plurality of batteries, according to an embodiment of the disclosure.

After the connection with the external charger 200 is disconnected, the processor 130 may receive SOC information of each battery from the plurality of batteries while the robot 100 is operating. As an example, the processor 130 may receive SOC information from the first battery 110-1 and the second battery 110-2 in operation S410.

Then, the processor 130 may determine a difference in the SOCs based on the SOC information received from each battery. As an example, the processor 130 may determine whether a difference between the first SOC which is the SOC of the first battery 110-1 and the second SOC which is the SOC of the second battery 110-2 is a difference threshold (or, greater than or equal to the difference threshold) in operation S420.

If it is determined that the difference between the first SOC and the second SOC has reached the difference threshold, the processor 130 may control the second switch 120-2 such that the first battery 110-1 and the second battery 110-2 are connected in operation S430. That is, the processor 130 may short the second switch 120-2 in an open state.

Accordingly, the battery having a relatively high SOC may charge the battery having a relatively low SOC in operation S450.

Meanwhile, if it is determined that the difference between the first SOC and the second SOC is smaller than the difference threshold, the processor 130 may maintain the second switch 120-2 in an open state as it is in operation S440.

While the battery having a relatively high SOC is charging the battery having a relatively low SOC, the processor 130 may receive SOC information from each battery, and determine whether the difference between the first SOC and the second SOC has reached a predetermined current threshold based on the information in operation S460.

Then, if it is determined that the difference between the first SOC and the second SOC has reached the predetermined current threshold, the processor 130 may control the second switch 120-2 to disconnect the connection between the first battery 110-1 and the second battery 110-2 in operation S470. That is, the processor 130 may open the second switch 120-2.

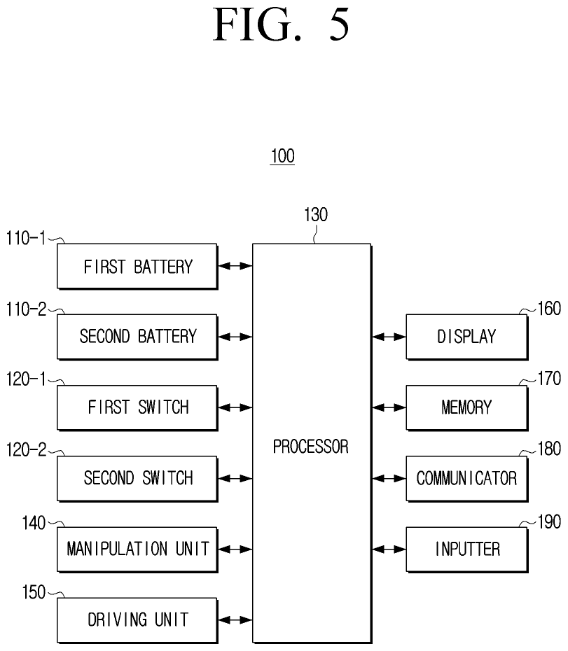

FIG. 5 is a detailed block diagram illustrating a robot, according to an embodiment of the disclosure.

Referring to FIG. 5, the robot 100 according to an embodiment of the disclosure may include a plurality of batteries (e.g., the first battery 110-1, the second battery 110-2), a plurality of switches (e.g., the first switch 120-1, the second switch 120-2), a manipulation unit 140, a driving unit 150, a display 160, a memory 170, a communicator 180, an inputter 190, and a processor 130. Hereinafter, explanation will be described by omitting or abridging parts that overlap with the aforementioned explanation.

The manipulation unit 140 is a component including, for example, a robot arm, a robot hand, and robot fingers, and here, one end of the robot arm may be connected to the body part of the robot 100, and the other end of the robot arm may be connected to the robot hand. Also, the robot hand may be connected to the robot fingers, and the robot fingers may be implemented as a plurality of fingers.

The manipulation unit 140 of the disclosed embodiment may further include a micro controller unit (MCU) and a plurality of motors. Here, the motors include a motor for controlling the robot arm, a motor for controlling the robot hand, and a motor for controlling the robot fingers, and each of the plurality of motors may be electrically connected to the MCU and some batteries among the plurality of batteries in the disclosure.

In addition, the MCU may be electrically connected to the processor 130 in the body part, and operate at least one of the plurality of motors based on a control signal received from the processor 130. As an example, if a signal for controlling the movement of the robot arm is received from the processor 130, the MCU may output an operation signal to the motor connected with the robot arm, and thereby control the movement of the robot arm.

Such an MCU may be included in the robot arm, but is not necessarily limited thereto, and the MCU may also be included in the robot hand, or elsewhere in the robot.

Also, the aforementioned motor may be a DC motor, but is not necessarily limited thereto, and the motor may be implemented as various motors that can generate a rotation force such as a step motor or an RC servo motor, etc.

The driving unit 150 may be connected to the bottom end of the body part of the robot 100, and control the movement of the robot 100.

The driving unit 150 of the disclosed embodiment may include an operation unit (not shown) implemented as a wheel or a robot leg, a motor (not shown), and an MCU (not shown), and the processor 130 may transmit a control signal for moving the robot 100 to the MCU (not shown) of the driving unit 150. In this case, the MCU (not shown) of the driving unit 150 may output an operation signal to the motor (not shown) connected to the operation unit (not shown) according to the control signal, and thereby move the robot 100.

The display 160 may display various screens. For example, the display 160 may display SOC information of the plurality of batteries included in the robot 100, information indicating that some batteries among the plurality of batteries are being charged by the external charger 200, or information indicating that some batteries among the plurality of batteries are being charged by some other batteries, etc.

The display 160 as above may be implemented as displays in various forms such as a liquid crystal display (LCD) panel, light emitting diodes (LED), organic light emitting diodes (OLED), liquid crystal on silicon (LCoS), digital light processing (DLP), etc. Also, inside the display 160, operation circuits that may be implemented in forms such as an a-si TFT, a low temperature poly silicon (LTPS) TFT, an organic TFT (OTFT), a backlight unit, etc. may also be included.

Further, the display 160 may be combined with a touch detection unit, and implemented as a touch screen.

The memory 170 may store an operating system (OS) for controlling the overall operations of the components of the robot 100, and instructions or data related to the components of the robot 100.

Accordingly, the processor 130 may control a plurality of hardware or software components of the robot 100 by using various instructions or data, etc. stored in the memory 170, and load instructions or data received from at least one of other components on a volatile memory and process them, and store various data in a non-volatile memory.

In particular, the memory 170 may store information on a difference threshold for short-circuiting of the second switch 120-2. Accordingly, if it is determined that the difference in the SOCs among the plurality of batteries has reached the difference threshold stored in the memory 170, the processor 130 may short-circuit the second switch 120-2, and charge the battery having a low SOC using the battery having a high SOC among the plurality of batteries.

The communicator 180 may communicate with an external device and transmit and receive various data. For example, the communicator 180 might not only perform communication with an electronic device through a local area network (LAN), an Internet network, and a mobile communication network, but might also perform communication with an electronic device through various communication methods such as Bluetooth (BT), Bluetooth low energy (BLE), wireless fidelity (WI-FI), Zigbee, NFC, etc.

For this, the communicator 180 may include various communication modules for performing network communication. For example, the communicator 180 may include a Bluetooth chip, a Wi-Fi chip, a wireless communication chip, etc.

The inputter 190 may receive input of various user instructions. The processor 130 may perform various functions according to user instructions input through the inputter 190.

For this, the inputter 190 may be implemented as an input panel. The input panel may be implemented in a key pad or touch screen type including a touch pad or various kinds of function keys, number keys, special keys, character keys, etc.

The aforementioned components are merely an example, and the robot 100 may further include components such as a sensor, etc. Here, the sensor may be a sensor for measuring distance such as an infrared sensor, a LiDAR sensor, or an ultrasonic sensor, etc., but is not necessarily limited thereto.

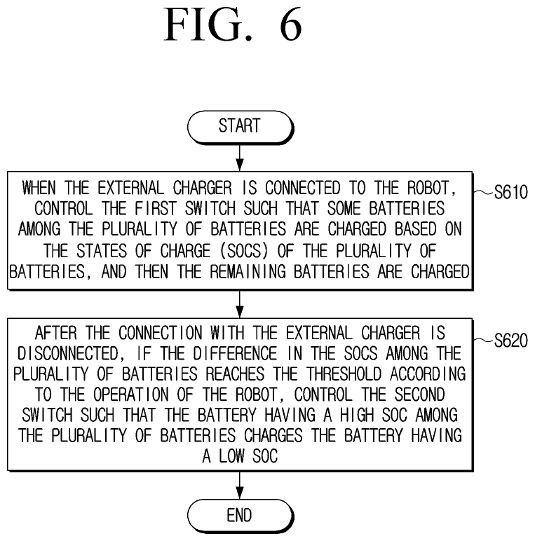

FIG. 6 is a flow chart for illustrating a control method for a robot, according to an embodiment of the disclosure.

When the external charger 200 is connected to the robot 100, the robot 100 may control the first switch 120-1 such that at least one battery of the plurality of batteries is selectively charged on the basis of the states of charge (SOCs) of the plurality of batteries, and then the remaining batteries are charged, in operation S610.

For this, the robot 100 may receive SOC information of each battery from the plurality of batteries, and determine a first battery having a relatively low SOC and a second battery having a relatively high SOC among the plurality of batteries based on the SOC information.

Then, when the first battery is charged to a predetermined SOC threshold by a CC charge method, the robot 100 may control the first switch 120-1 such that the second battery and the external charger 200 are connected.

Then, when the second battery is charged to the predetermined SOC threshold by the CC charge method, the robot 100 may control the first switch 120-1 such that the first battery and the external charger 200 are connected, and charge the first battery 110-1 by a CV charge method.

Afterwards, when the first battery 110-1 is fully charged by the CV charge method, the robot 100 may control the first switch 120-1 such that the second battery 110-2 and the external charger 200 are connected, and fully charge the second battery 110-2 by the CV charge method.

After the external charger 200 is disconnected, if a difference in respective SOCs among the plurality of batteries reaches a difference threshold according to the operation of the robot 100, the robot 100 may control the second switch 120-2 such that a “source” battery having a high relative SOC among the plurality of batteries charges a “recipient” battery having a low relative SOC in operation S620.

For this, while the robot 100 is operating, the robot 100 may receive SOC information from the plurality of batteries, and determine the difference in the SOCs of the plurality of batteries based on the SOC information.

Then, when the difference in the SOCs of the plurality of batteries reaches a predetermined current threshold as the source battery having a high relative SOC charges the recipient battery having a low relative SOC, the robot 100 may control the second switch 120-2 to disconnect the connection between the source battery and recipient battery. That is, the robot 100 may open the second switch 120-2 in a shorted state.

The methods according to the aforementioned various embodiments of the disclosure may be implemented in forms of software or applications that can be installed on conventional robots.

Also, the methods according to the aforementioned various embodiments of the disclosure may be implemented just with software upgrade, or hardware upgrade of conventional robots.

Further, a non-transitory computer readable medium storing a program that sequentially performs the control method for a robot according to the disclosure may be provided.

A non-transitory computer readable medium refers to a medium that stores data permanently or semi-permanently, and is readable by machines, but not a medium that stores data for a short moment such as a register, a cache, and a memory. Specifically, the aforementioned various applications or programs may be provided while being stored in a non-transitory computer readable medium such as a CD, a DVD, a hard disk, a blue-ray disk, a USB, a memory card, a ROM and the like.

Also, while preferred embodiments of the disclosure have been shown and described, the disclosure is not limited to the aforementioned specific embodiments, and it is apparent that various modifications may be made by those having ordinary skill in the technical field to which the disclosure belongs. Further, it is intended that such modifications are not to be interpreted independently from the technical idea or prospect of the disclosure.

What is claimed is:

1. A robot comprising:
a plurality of batteries;
a first switch configured to individually supply electric energy provided from an external charger to the plurality of batteries;
a second switch configured to connect the plurality of batteries; and
a processor configured to:
based on the external charger being connected to the robot, control the first switch such that at least one battery of the plurality of batteries is selectively charged based on respective states of charge (SOCs) of the plurality of batteries, and then remaining batteries of the plurality of batteries are charged, and
based on an SOC difference between respective SOCs of at least two of the plurality of batteries reaching a difference threshold while the external charger is disconnected from the robot, control the second switch such that a source battery having a high relative SOC among the plurality of batteries charges a recipient battery having a low relative SOC among the plurality of batteries.

2. The robot of claim 1, wherein the processor is further configured to:
receive SOC information of each battery of the plurality of batteries,
based on the SOC information, control the first switch to connect the external charger with a first battery having a low relative SOC among the plurality of batteries, to thereby charge the first battery, and
after the first battery is charged, control the first switch to connect the external charger with a second battery having a higher SOC than the first battery among the plurality of batteries, to thereby charge the second battery.

3. The robot of claim 2, wherein the processor is further configured to:
based on the first battery being charged to a predetermined SOC threshold by a constant current (CC) charge method, control the first switch to connect the second battery with the external charger.

4. The robot of claim 3, wherein the processor is further configured to:
based on the second battery being charged to the predetermined SOC threshold by the CC charge method, control the first switch to connect the first battery with the external charger, and charge the first battery by a constant voltage (CV) charge method, and
based on the first battery being fully charged by the CV charge method, control the first switch to connect the second battery with the external charger, and fully charge the second battery by the CV charge method.

5. The robot of claim 1, wherein the processor is further configured to:
while the robot is operating, receive SOC information from the plurality of batteries, and determine the SOC difference based on the SOC information.

6. The robot of claim 1, wherein the processor is further configured to:
based on the SOC difference reaching a predetermined current threshold while the source battery charges the recipient battery, control the second switch to disconnect the source battery and the recipient battery.

7. The robot of claim 1, wherein, based on a current flowing to the plurality of batteries having a value greater than or equal to a predetermined current threshold, the plurality of batteries perform an overcurrent protection function, and
wherein the difference threshold is set for the robot such that the value of the current flowing from the source battery to the recipient battery is smaller than the predetermined current threshold.

8. The robot of claim 1, wherein at least one battery of the plurality of batteries is configured to supply electric energy to a motor of the robot, and at least one other battery of the plurality of batteries is configured to supply electric energy to the processor.

9. A control method for a robot, the control method comprising:
based on an external charger being connected to the robot, controlling a first switch such that at least one battery among a plurality of batteries of the robot is selectively charged based on respective states of charge (SOCs) of the plurality of batteries, and then remaining batteries of the plurality of batteries are charged; and
based on an SOC difference between respective SOCs of at least two of the plurality of batteries reaching a difference threshold while the external charger is disconnected from the robot, controlling a second switch such that a source battery having a high relative SOC among the plurality of batteries charges a recipient battery having a low relative SOC among the plurality of batteries.

10. The control method of claim 9, wherein the controlling the first switch comprises:
receiving SOC information of each battery from the plurality of batteries;
based on the SOC information, controlling the first switch to connect the external charger with a first battery having a low relative SOC among the plurality of batteries, to thereby charge the first battery, and
after the first battery is charged, controlling the first switch to connect the external charger with a second battery having a higher SOC than the first battery among the plurality of batteries, to thereby charge the second battery.

11. The control method of claim 10, wherein the controlling the first switch comprises:
based on the first battery being charged to a predetermined SOC threshold by a constant current (CC) charge method, controlling the first switch to connect the second battery with the external charger.

12. The control method of claim 11, wherein the controlling the first switch comprises:
based on the second battery being charged to the predetermined SOC threshold by the CC charge method, controlling the first switch to connect the first battery with the external charger, and charging the first battery by a constant voltage (CV) charge method, and
based on the first battery being fully charged by the CV charge method, controlling the first switch to connect the second battery with the external charger, and fully charging the second battery by the CV charge method.

13. The control method of claim 9, further comprising:
while the robot is operating, receiving SOC information from the plurality of batteries, and determining the SOC difference based on the SOC information.

14. The control method of claim 9, wherein the controlling the second switch comprises:
based on the SOC difference reaching a predetermined current threshold while the source battery charges the recipient battery, controlling the second switch to disconnect the source battery and the recipient battery.

15. The control method of claim 9, wherein, based on a current flowing to the plurality of batteries having a value greater than or equal to a predetermined current threshold, the plurality of batteries perform an overcurrent protection function, and
wherein the difference threshold is set for the robot such that the value of the current flowing from the source battery to the recipient battery is smaller than the predetermined current threshold.
